(19) United States
(12) Patent Application Publication
(10) Pub. No.: US 2021/0315206 A1
(43) Pub. Date: Oct. 14, 2021

(54) Treatment of Plants Against Disease

(71) Applicant: Henry Manufacturing Limited, Auckland (NZ)

(72) Inventor: Christopher Henry, Hastings (NZ)

(21) Appl. No.: 17/285,305

(22) PCT Filed: Sep. 16, 2019
(86) PCT No.: PCT/NZ2019/050124

§ 371 Date: Apr. 14, 2021

(30) Foreign Application Priority Data
Jan. 14, 2019 (NZ) 749953
Jul. 1, 2019 (NZ) 755033

(51) Int. Cl. A01N 37/02; A01N 25/04; A01N 59/00

(52) U.S. Cl. CPC A01N 37/02; A01N 59/00; A01N 25/04

(57) ABSTRACT

Averting plant diseases is an ongoing battle in the agricultural and horticultural industries. Some diseases are minor; however others such as Xanthomonas present a serious problem, causing significant adverse economic impact. It is an object of the invention to go at least some way towards addressing this or to provide the public with a useful choice. The invention comprises a method of treating a plant against disease resulting from pathogens of Proteobacteria (eg Xanthomonas), comprising applying to the plant fatty acid and silicate.

### FIELD OF THE INVENTION

A preferred form of the invention relates to the treatment of plants against disease caused by pathogens of Proteobacteria (for example Xanthomonas bacteria).

A particularly preferred form of the invention relates to the treatment of cruciferous vegetables and their plant parts to prevent or reduce infection by ‘black rot’ caused by Xanthomonas campestris pv. campestris.

### BACKGROUND

Averting plant diseases is an ongoing battle in the agricultural and horticultural industries. Some diseases are minor; however others such as Xanthomonas present a serious problem, causing significant adverse economic impact.

Xanthomonas species can cause cankers, bacterial spots and blights on leaves, stems, branches and fruits in a wide variety of plant species. Pathogenic species show high degrees of specificity and some are split into multiple pathovars, a species designation based on host specificity.

Diseases caused by Xanthomonas are of particular concern to growers of a wide range of crops including, but not limited to, cruciferous vegetables such as cabbage, broccoli, cauliflower etc., solanaceae vegetables such as tomatoes, peppers etc., tree crops such as citrus, stone fruits etc., nut crops such as walnut, hazelnut, etc., and grains such as wheat, barley or rice.

Spraying agricultural treatments is one of the more effective methods for managing infection by for the prevention or suppression of disease symptoms caused by Xanthomonas bacteria. They fall into three main groups depending on the plant to be treated and the circumstances of the infection.

Copper-based fungicides are commonly used to treat diseases caused by Xanthomonas, but in general they cannot be used long term as they may lead to undesirable levels of copper accumulating in the surrounding soil. Further, Xanthomonas bacteria can become too readily resistant to copper in certain crops, therefore requiring higher rates to keep control of the disease. Copper can also be quite toxic to certain important soil organisms.

There is a relatively limited range of antibiotics available for treatment of plant diseases, and their long-term use heightens the risk of plants becoming resistant to them. Additionally there are often objections to these treatments based on the fear of humans acquiring resistance to the antibiotics, ie through consuming food produced using them. Antibiotics commonly used for treating diseases caused by Xanthomonas comprise streptomycin and kasugamycin based products.

There are some so-called ‘soft’ pesticide alternatives that require no withholding period because of their lack of any significant residual toxicity. Many are in the category of ‘biologicals’, which are organisms that prevent or influence the disease, or elicit heightened plant resistance to the disease. In many cases, when they are tested against either copper or antibiotic applications, many biologicals or ‘elicitors’ fall short in terms of efficacy. In some cases their mode of action requires particular climatic conditions, which may or may not exist in the environment at hand.

### OBJECT OF THE INVENTION

It is an object of preferred embodiments of the invention to at least go some way towards averting plant diseases caused by pathogens of Proteobacteria, for example Xanthomonas bacteria, and particularly Xanthomonas campestris pv. camprestris. While this object applies to preferred embodiments, it should not be seen as a limitation on any claims expressed more broadly. The object of the invention per se is simply to provide the public with a useful choice.

### Definitions

The term “comprising” or derivatives thereof, eg “comprises”, if and when used in this document in relation to a combination of features should not be seen as excluding the option of additional unspecified features or steps. In other words, the term should not be interpreted in a limiting way.

### SUMMARY OF THE INVENTION

According to one aspect of the invention there is provided a method of treating a plant against disease resulting from pathogens of Proteobacteria, for example from Xanthomonas, comprising applying to the plant:
fatty acid in soap form; and
silicate;
   wherein the fatty acid is in solution or in suspension in water.

Optionally the method comprises applying a composition comprising the fatty acid and the silicate.

Optionally the Xanthomonas is bacterial and comprises Xanthomonas campestris pv. campestris.

The fatty acid and silicate kill, inhibit, directly control or eliminate the Xanthomonas bacteria.

Optionally the fatty acid comprise one or more of:
sodium salt; and
potassium salt.

Optionally the fatty acid comprises fat of animal origin.

Optionally the fatty acid comprises oil of plant origin.

Optionally the fatty acid comprises fat and oil of plant or animal origin.

Optionally fatty acid comprises one or more of the following—
Caproic Acid
Caprylic Acid
Capric Acid
Lauric Acid
Myristic Acid
Palmitic Acid
Stearic Acid
Oleic Acid
Linoleic Acid
Linolenic Acid
Arachidic Acid

Optionally fatty acid comprises one or more of the following*—
C6:0: Caproic Acid
C8:0: Caprylic Acid
C10:0: Capric Acid
C12:0: Lauric Acid
C14:0: Myristic Acid
C16:0: Palmitic Acid
C18:0: Stearic Acid
C18:1: Oleic Acid
C18:2: Linoleic Acid
C18:3: Linolenic Acid
C20:0: Arachidic Acid
The number immediately following the “C” term notes the number of carbon atoms in the molecule, and the number immediately after that designates the number of double bonds in the carbon chain. So for example “06:0 Caproic acid” indicates that the molecule has ‘6’ carbon atoms and ‘0’ double bonds.

Optionally the silicate is water soluble.

Optionally the silicate is in the form of metallic salt.

Optionally the silicate comprises one or more of:
potassium silicate;
sodium silicate; and
lithium silicate;

Optionally the molar ratio of the silicate ranges from 2.0 to 3.3. By way of example, if the silicate is potassium silicate and the molar ratio is 2.0, this means it contains 2.0 mol of SiO₂ for every 1 mol of K₂O. And if the silicate is potassium silicate at a molar ratio of 3.3, it contains 3.3 mol of SiO₂ for every 1 mol of K₂O.

Optionally the plant comprises one or more of a fruit, vegetable, nut, flower, grain or tree.

Optionally the fruit comprises one or more of citrus, peaches, nectarines, apricots, plums, cherries, tamarillos, pomegranates and berry fruit.

Optionally the vegetable comprises one or more of lettuce, brassicas, cucurbits, tomato, capsicum, chili, potato, sweet potato, carrots, beet, spring onions, leeks, beans and peas.

Optionally the grain comprises one or more of wheat, maize, sorghum, oats, rice and barley.

Optionally the tree comprises an ornamental variety selected from one or more of begonia, roses, ivy, geranium and poinsettia.

According to a further aspect, the invention comprises the use of:
fatty acid; and
silicate;
   in the preparation of a composition for treating a plant against disease resulting from pathogens of Proteobacteria, for example from Xanthomonas (eg Xanthomonas campestris pv. campestris). Preferably the fatty acid and/or silicate and/or plant are as per any of the options set out above.

### DRAWINGS

Some preferred embodiments of the invention will now be described by way of example and with reference to the accompanying drawings, of which:

FIGS. 1-7 graph, logarithmically, the bacterial count in the presence of solutions of potassium soap alone, potassium silicate alone and a number of concentrations of individual potassium soaps and potassium silicate, and the efficacy effect achieved by the various concentrations of potassium silicate to various concentrations of potassium soap when used against Xanthomonas campestris pv. campestris.

### DETAILED DESCRIPTION

In a preferred embodiment of the invention there is a composition for treating plants as above, against diseases as above. The composition is in the form of a solution for spraying, consisting of components as listed in the following examples.

### Example 1

| Component | Amount | Function |
|---|---|---|
| 18.2 % w/v fatty acid | 0.08-2 L | Active |
| potassium salt in water | | ingredient |
| (ie 182 g potassium salt | | |
| of fatty acid per litre of | | |
| water) | | |
| A 44% w/v potassium | 21.6-540 mL | Active |
| silicate water solution (ie | (approximately | ingredient |
| 440 g potassium silicate | 80 ppm to | |
| per litre of water) | 2000 ppm Silica) | |
| Water | 100 L | Diluent-solvent |

To produce the above composition, the silicate solution is added to about ¾ of the total water with stirring. The fatty acid potassium salt (in salt form) is then added with stirring. The balance of the water is then added with stirring.

The composition is in the form of a spray mixture ready to apply to plants by way of a manual or machine sprayer. Spraying is preferably liberal, such that excess composition runs off substantially all plant surfaces at critical plant growth stages, before disease occurs.

### Example 2

The table below lists a number of specific prototype soap formulations produced in accordance with preferred embodiments of the invention.

| Formulation | Contents |
|---|---|
| NS1 | Potassium soap derived from fully refined, |
| | bleached and deodorised coconut oil (RBD |
| | Coconut Oil from Oilseed Products NZ Ltd). |
| NS2 | Potassium soap derived from fully refined, |
| | bleached deodorised palm olein (RBD Palm |
| | Olein from Oilseed Products NZ Ltd). |

The formulations NS1 and NS2 were produced by saponification. In this regard 1.63 kg of the oil component in each case was reacted with 420 g of potassium hydroxide in 2.5 L water. To assist the reaction, 360 g of liquid potassium soap was added to the oil prior to the addition of the potassium hydroxide. The resulting concentrated solution was then buffered to a pH of approximately 10 using citric acid based buffer. Approximately 5 L of water was then added to make each formulation up to a final volume of 10 L. The amount of potassium salt of fatty acid in each of the “NS” soap formulation came out at approximately 18% w/v, or in other words 180 g/L soap per litre of water.

The fatty acid profile for NS1 and NS2 are generally as follows:

| NS1 | Proportion % w/w |
|---|---|
| C6:0: Caproic Acid | 0-1.0 |
| C8:0: Caprylic Acid | 8.0 |
| C10:0: Capric Acid | 6.0 |
| C12:0: Lauric Acid | 47.0 |
| C14:0: Myristic Acid | 18.0 |
| C16:0: Palmitic Acid | 9.0 |
| C18:0: Stearic Acid | 3.0 |
| C18:1: Oleic Acid | 6.0 |
| C18:2: Linoleic Acid | 2.0 |

| NS2 | Proportion % w/w |
|---|---|
| C12:0: Lauric Acid | 0-1.0 |
| C14:0: Myristic Acid | 0.5-1.5 |
| C16:0: Palmitic Acid | 37.0-42.0 |
| C18:0: Stearic Acid | 3.0-5.5 |
| C18:1: Oleic Acid | 40.0-45.0 |
| C18:2: Linoleic Acid | 9.0-13.0 |
| C18:3: Linolenic Acid | 0.0-1.0 |
| C20:0: Arachidic Acid | 0.0-1.0 |

These NS1 and NS2 prototype soap formulations were used in a number of in-vitro studies, both individually and in combination with potassium silicate, as described below.

In Vitro Treatment of Xanthomonas campestris pv. campestris

Laboratory trials were run to compare the effectiveness of certain embodiments of the invention against Xanthomonas campestris pv. campestris. The trial measured the bacterial count observed in the presence of the following test compositions:
NS1 and NS2 alone (each approximately 18% w/v potassium salts of fatty acids);
potassium silicate alone (concentration 44% w/v, molar ratio 2.2);
the combination of each ‘NS.’ component and silicate;
Kasugamycin (an industry standard antibiotic);
Streptomycin (an industry standard antibiotic)
Distilled water alone.

The test compositions are listed in the table below.

| Product | Units | Treatment Rates | | | | | | | | | | | | | | | | Total |
|---|---|---|---|---|---|---|---|---|---|---|---|---|---|---|---|---|---|---|
| NS1 | L/100 L | 0.08 | 0.4 | 1 | 2 | | | | | | | | | | | | | 4 |
| NS2 | L/100 L | 0.08 | 0.4 | 1 | 2 | | | | | | | | | | | | | 4 |
| Potassium | mL/100 L | 21.6 | 108 | 270 | 540 | | | | | | | | | | | | | 4 |
| silcate | | | | | | | | | | | | | | | | | | |
| NS1 + | L/100 L | 0.08 | 0.08 | 0.08 | 0.08 | 0.4 | 0.4 | 0.4 | 0.4 | 1 | 1 | 1 | 1 | 2 | 2 | 2 | 2 | 16 |
| Potassium | NS1 | | | | | | | | | | | | | | | | | |
| silicate | mL/100 L | 21.6 | 108 | 270 | 540 | 21.6 | 108 | 270 | 540 | 21.6 | 108 | 270 | 540 | 21.6 | 108 | 270 | 540 | |
| | Potassium | | | | | | | | | | | | | | | | | |
| | silicate | | | | | | | | | | | | | | | | | |
| NS2 + | L/100 L | 0.08 | 0.08 | 0.08 | 0.08 | 0.4 | 0.4 | 0.4 | 0.4 | 1 | 1 | 1 | 1 | 2 | 2 | 2 | 2 | 16 |
| Potassium | NS2 | | | | | | | | | | | | | | | | | |
| silicate | | | | | | | | | | | | | | | | | | |
| | mL/100 L | 21.6 | 108 | 270 | 540 | 21.6 | 106 | 270 | 540 | 21.6 | 108 | 270 | 540 | 21.6 | 108 | 270 | 540 | |
| | Potassium | | | | | | | | | | | | | | | | | |
| | silicate | | | | | | | | | | | | | | | | | |
| Water | | 1 | | | | | | | | | | | | | | | | 2 |
| Streptomycin | g/100 L | 10.2 | | | | | | | | | | | | | | | | 1 |
| sulphate | | | | | | | | | | | | | | | | | | |
| Kasumin | L/100 L | 0.5 | | | | | | | | | | | | | | | | 1 |
| (20 g/L | | | | | | | | | | | | | | | | | | |
| kasugamycin) | | | | | | | | | | | | | | | | | | |

| | |
|---|---|
| Total Treatment Number | 48 |

NS1, NS2 and the potassium silicate product were evaluated for their efficacy on an agar plate, in terms of their ability to control growth of Xanthomonas campestris pv. campestris at predetermined concentrations and combinations, a total of 53 treatments per replicate (see table above).

Two positive controls (Streptomycin and Kasumin (20 g/L kasugamycin)) and a negative control (distilled water) were also included.

Each of the products was prepared to four times the required concentration. A 0.25 mL aliquot of each of these solutions was combined with 0.25 mL of potassium silicate (or water) and 0.5 mL of bacterial suspension making a total volume of 1 mL. The solutions containing the products and bacteria were then incubated for 1 h at 20° C. prior to diluting in a ten-fold series in sterile distilled water down to 10⁻⁷. The diluted solutions were then plated to Casitone-yeast extract agar (CYE agar) (Araújo et al. 2012), and incubated at 20° C. until individual bacterial colonies could be enumerated.

Each solution was separately made as three true replicates. Treatment means for each replicate were averaged over the three replicates. Treatments were randomized but not statistically analysed as the large number of zeros nullified the ANOVA model. All data were presented on a logarithmic scale to enable differences in bacterial concentrations to be visualized.

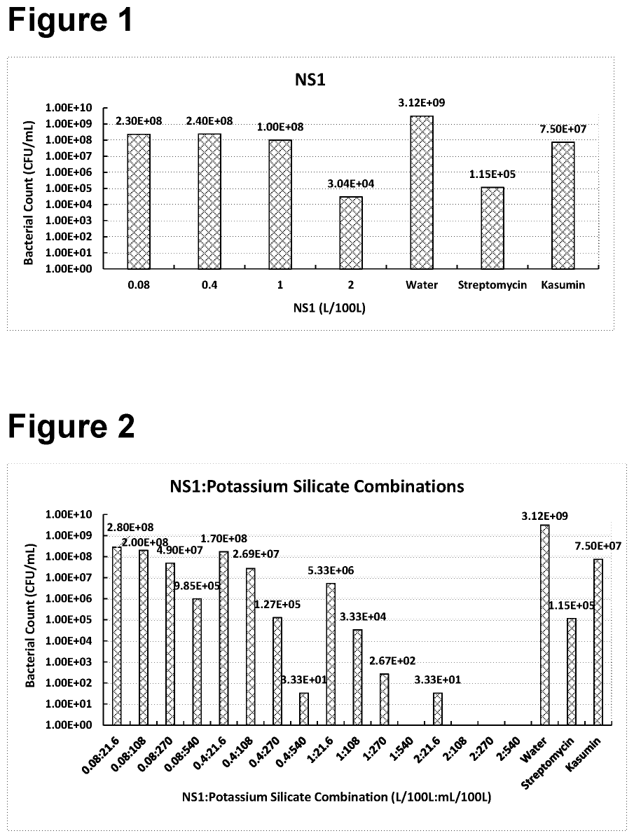

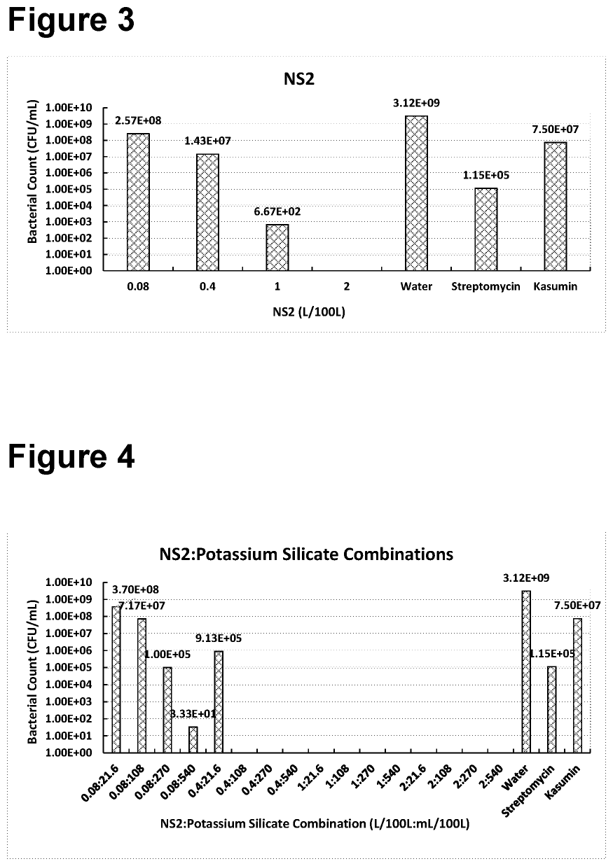

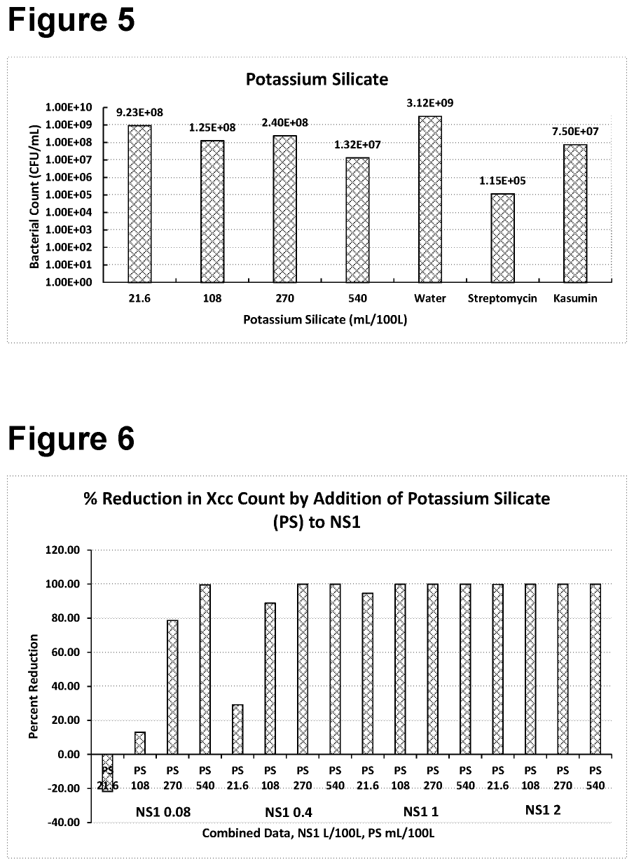

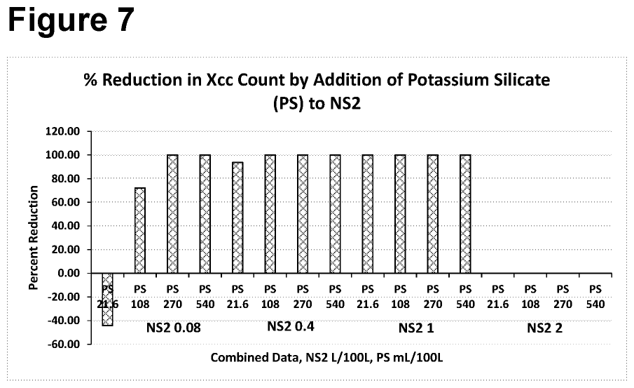

The bacterial colony count results for each sample are as shown at FIGS. 1-5.

While some preferred embodiments of the invention have been exemplified, it should be appreciated that modifications and improvements can occur without departing from the scope of the following claims.

In terms of disclosure, this document hereby discloses each item, feature or step mentioned herein in combination with one or more of any of the other item, feature or step disclosed herein, in each case regardless of whether such combination is claimed.

1. A method of treating a plant against disease resulting from Xanthomonas bacteria, comprising applying to the plant:
fatty acid in the form of soap; and
silicate;
wherein the fatty acid is in solution or in suspension in water.

2. A method according to claim 1, comprising applying to the plant a composition comprising the fatty acid and silicate.

3. A method according to claim 1, wherein the disease results from Xanthomonas campestris pv. campestris.

4. A method according to claim 1, wherein the fatty acid and silicate kill the Xanthomonas bacteria.

5. A method according to claim 1, wherein the fatty acid and silicate inhibit the Xanthomonas bacteria.

6. A method according to claim 1, wherein the fatty acid and silicate directly control the Xanthomonas bacteria.

7. A method according to claim 1, wherein the fatty acid and silicate directly eliminate the Xanthomonas bacteria.

8. A method according to claim 1, wherein the fatty acid is in the form of one or more of:
sodium salt; and
potassium salt.

9. (canceled)

10. (canceled)

11. (canceled)

12. A method according to claim 1, wherein the fatty acid comprises one or more of the following—
Caproic Acid
Caprylic Acid
Capric Acid
Lauric Acid
Myristic Acid
Palmitic Acid
Stearic Acid
Oleic Acid
Linoleic Acid
Linolenic Acid
Arachidic Acid

13. A method according to claim 1, wherein the fatty acid comprises one or more of the following—
C6:0: Caproic Acid
C8:0: Caprylic Acid
C10:0: Capric Acid
C12:0: Lauric Acid
C14:0: Myristic Acid
C16:0: Palmitic Acid
C18:0: Stearic Acid
C18:1: Oleic Acid
C18:2: Linoleic Acid
C18:3: Linolenic Acid
C20:0: Arachidic Acid

14. A method according to claim 1, wherein the silicate is water soluble.

15. A method according to claim 1, wherein the silicate is in the form of metallic salt.

16. A method according to claim 1, wherein the silicate comprises one or more of:
potassium silicate;
sodium silicate;
lithium silicate;

17. A method according to claim 1, wherein the molar ratio of the silicate is from 2.0 to 3.3.

18. A method according to claim 1, wherein the plant comprises one or more of a fruit, vegetable, nut, flower, grain and tree.

19. (canceled)

20. (canceled)

21. (canceled)

22. (canceled)

23. The use of:
fatty acid; and
silicate;
in the preparation of a composition for treating a plant against disease resulting from Xanthomonas bacteria.

24. A use as claimed in claim 23, wherein the disease comprises Xanthomonas campestris pv. campestris.

25. (canceled)

26. (canceled)

27. A method according to claim 1, wherein:
a) the disease is one resulting from Xanthomonas campestris pv. campestris;
b) the fatty acid is in the form of one or more of:
sodium salt; and
potassium salt; and
c) the silicate comprises one or more of:
potassium silicate;
sodium silicate; and
lithium silicate.

28. A method according to claim 1, wherein:
a) the disease is one resulting from Xanthomonas campestris pv. campestris;
b) the silicate is water soluble; and
c) the fatty acid comprises one or more of—
Caproic Acid;
Caprylic Acid;
Capric Acid;
Lauric Acid;
Myristic Acid;
Palmitic Acid;
Stearic Acid;
Oleic Acid;
Linoleic Acid;
Linolenic Acid; and
Arachidic Acid.
